(19) United States
(12) Patent Application Publication
(10) Pub. No.: US 2026/0221770 A1
(43) Pub. Date: Jul. 30, 2026

(54) METHOD FOR OPERATING A VIRTUAL POWER PLANT

(71) Applicant: Viessmann Holding International GmbH, Allendorf (Eder) (DE)

(72) Inventors: Fabian HASLBECK, Goettingen (DE); Moritz LAUSTER, Berlin (DE)

(73) Assignee: Viessmann Holding International GmbH, Allendorf (Eder) (DE)

(21) Appl. No.: 19/574,329

(22) Filed: Mar. 21, 2026

Related U.S. Application Data
(63) Continuation of application No. PCT/EP2024/076253, filed on Sep. 19, 2024.

(30) Foreign Application Priority Data
Sep. 21, 2023 (DE) 10 2023 209 210.7

(51) Int. Cl. H02J 3/001; H02J 13/12

(52) U.S. Cl. CPC H02J 3/001; H02J 13/12

(57) ABSTRACT

A method for operating a virtual power plant which comprises a plurality of electrical consumers, at least one of which is formed by a heat pump. A current operating state of each consumer is acquired and a control record for the consumers is created. The consumers are operated in accordance with the control record. The control record is created such that an auxiliary variable, which is created based on the current operating states and on a deviation between a setpoint value for a power requirement and a forecast value that corresponds to a power requirement of the consumers during operation in accordance with the control record, is minimal. A virtual power plant and a computer program product are also provided.

This nonprovisional application is a continuation of International Application No. PCT/EP2024/076253, which was filed on September 19, 2024, and which claims priority to German Patent Application No. 10 2023 209 210.7, which was filed in Germany on September 21, 2023, and which are both herein incorporated by reference.

### BACKGROUND OF THE INVENTION

### Field of the Invention

The invention relates to a method for operating a virtual power plant. The virtual power plant comprises a plurality of electrical consumers, at least one of which is a heat pump. In particular, the virtual power plant is in particular in a power class between 50 kW and 200 kW. The invention further relates to a virtual power plant and to a computer program product.

### Description of the Background Art

Electricity generators powered by regenerative/renewable energies are increasingly being used to generate electricity. Such electricity generators are, for example, photovoltaic systems or wind turbines. Due to the dependence on solar radiation or the prevailing wind, the electrical current provided by the power generators is not constant over time. Thus, in a supply network to which the power generators are connected, a time-fluctuating electrical power is provided, which can also lead to fluctuations in the electrical voltage supplied. In other words, grid stability is impaired. If the grid stability or the electrical voltage supplied by the supply network fluctuates comparatively strongly, it is possible that at least some of the consumers operated with it will have malfunctions. In order to avoid damaging these consumers, they are therefore switched off, for example. If one of these consumers is part of an industrial plant, this results in production losses.

By means of theoretical models, it is possible to make a comparatively accurate forecast of the weather for a limited future period of time, such as a day, and thus also of the solar radiation and the prevailing wind. Therefore, it is also possible to estimate the electrical power provided by the electricity generators powered by these renewable energies over time. To simplify the organization, several such power generators are combined into a so-called virtual power plant. This takes advantage of the fact that individual power generators can complement each other, as individual photovoltaic systems are exposed to different levels of solar radiation due to different geographical locations, for example, in the case of prevailing clouds. Thus, the electrical power provided by the individual photovoltaic systems shows comparatively high fluctuations in each case. However, these are at least partially balanced out when the photovoltaic systems are combined, and a more uniform electrical output is provided by means of the virtual power plant.

In most cases, (electrical) consumers are also added to the virtual power plant, by means of which electrical power can be consumed flexibly in terms of time. Such a consumer is, for example, an electrical energy storage system. By means of this, at least part of the electrical power provided by the power generators is stored if it is above a certain limit. If a comparatively low electrical power is then provided by the power generators, electrical energy is taken from the energy storage system and fed into the supply grid, which leads to further uniformity. However, an energy storage system is required.

Alternatively or in combination, a so-called electric vehicle is used as a consumer. This is charged when a comparatively high electrical power is provided by means of the power generators. In a further development, if a reduced electrical power is provided by means of the power generators, electrical energy is at least partially withdrawn from the electric vehicle and fed into the supply grid, so that the electric vehicle is used in the manner of an energy storage system.

In a further development, the virtual power plant does not include any electricity generators, but only consumers, which, however, offer flexibility in terms of operating times. In this case, the consumers are operated only or at least mainly when an excessive amount of electrical power is fed into the supply network. In this way, the virtual power plant stabilizes the supply grid without the need to reduce the electrical power provided by the power generators. Since the consumers are also operated as desired, the electrical energy consumed by the virtual power plant is actually used, so that efficiency is increased.

The requirements for the consumers used are that comparatively large quantities of electrical energy can be consumed, if necessary even for a comparatively short period of time. In addition, any inconvenience to potential users of the consumer due to flexible operation should be negligible or imperceptible. For this reason, only the abovementioned energy storage systems, which are explicitly available for stabilization, or electric vehicles are typically used as corresponding consumers.

### SUMMARY OF THE INVENTION

It is therefore an object of the present invention to provide a particularly suitable method for operating a virtual power plant as well as a particularly suitable virtual power plant and a particularly suitable computer program product, wherein an area of application is advantageously extended, and wherein, expediently, compatibility and/or robustness is increased.

In an example, the method is used to operate a virtual power plant. The virtual power plant has several electrical consumers, which are also referred to in particular simply as consumers. Preferably, the virtual power plant has a supply connection to connect to a supply network. Thus, it is possible to feed the virtual power plant by means of the supply network and/or to transfer electrical energy between the supply network and the virtual power plant. In particular, an alternating electrical voltage is carried by means of the supply network, which is preferably three-phase. In particular, the electrical voltage connected to the supply network is 230 V or 110 V, and the frequency in particular is 50 Hz or 60 Hz.

The consumers are suitably interconnected with each other. For example, consumers can be arranged within a certain area or expediently decentralized. If all consumers are located within a common area, it is advisable for them to be electrically contacted to the supply network via the common supply connection. However, if the consumers are decentralized, each consumer is assigned a share of the supply connection, for example. For example, some or all of the consumers are assigned to the same building/structural unit, such as a private household or an industrial plant.

By means of the consumers, a decrease in electrical power takes place during operation. It is preferable to operate the consumers flexibly, at least for a limited period of time. The consumers or at least some of them are suitable, appropriately provided and configured for this purpose. Appropriately, the virtual power plant has between 10 consumers and 200 such consumers, preferably between 50 consumers and 150 consumers and, appropriately, essentially 100 consumers, wherein, for example, there is a tolerance of up to 20 consumers, 10 consumers or 0 consumers in each case.

In particular, the electrical power required by the virtual power plant due to the operation of the consumers is between 50 kW and 200 kW. Appropriately, the required power is greater than 60 kW or 80 kW. Preferably, the maximum power required is less than 150 kW or 120 kW. Conveniently, the required power is essentially equal to 100 kW, with a tolerance of up to 20 kW, 10 kW or 0 kW in each case. Appropriately, the number and/or type of consumers is adapted to a corresponding required power, or these are selected accordingly.

For example, one of the consumers can be an energy storage system, or an electric vehicle that is electrically connected to other components of the virtual power plant, in particular via a so-called wallbox or a charging station. At any rate, the electric vehicle is not used for transportation if it is a component of the virtual power plant and is electrically contacted, for example directly or via other components, with the potential supply connection. If, for example, the electric vehicle is used by a consumer, it is no longer possible to charge it, so that it is no longer part of the virtual power plant, at least temporarily.

At least one of the consumers can be a heat pump. The heat pump, for example, is equipped in the manner of an air conditioner. However, it is particularly preferred for the heat pump to be a component of a heating system, which is conveniently a component of the virtual power plant. Preferably, a plurality of the consumers are formed by means of a heat pump each, and for example, each of the consumers is formed by means of a heat pump.

The heat pump can be used to heat up a thermal buffer storage tank for the heating system in particular, especially a water storage tank. The heat pump suitably has an electric motor for this purpose, which drives a compressor. This means that the heat pump can be operated comparatively flexibly, as the thermal buffer storage tank has a certain inertia. In other words, the electrical flexibility in the operation of the heat pump is provided due to the inertia of the thermal buffer storage tank. In summary, it is particularly possible to operate the heating system for at least a certain period of time with a temperature of the thermal buffer storage tank that is (slightly) above or below a desired operating temperature, without any loss of comfort, at least excessively, for a user of the heat pump.

However, in a heat pump, especially in comparison to an energy storage system, the consumed/required electrical power depends on the current operating parameters of the heat pump and/or environmental parameters, such as the current temperature of the thermal buffer storage tank and/or the temperature of the ambient air. In addition, there are boundary conditions for the operation of the heat pump, such as the thermal buffer storage tank not being heated above a certain critical temperature. It is also necessary that the thermal buffer storage tank has a certain minimum temperature so that at least slight heating/maintenance of the temperature of the structural unit to which the heat pump is assigned can take place. This means that the boundary conditions to be observed with the heat pump are greater as compared to an energy storage system, for example, wherein safety aspects must also be taken into account.

For example, the virtual power plant only includes the consumers, so that it only consumes electrical energy. Alternatively, the virtual power plant has one or more electricity generators that are operated in particular by means of regenerative/renewable energies. For example, one of the electricity generators is a photovoltaic system or a wind turbine. Appropriately, the virtual power plant includes several such power generators, at least some of which are photovoltaic systems and some of which are wind turbines.

The method records the current operating state of each consumer. In other words, it is determined in particular whether the respective consumer is being operated. For example, each or part of the operating states is only determined in binary terms. In a further development, the currently required electrical power is also determined. For example, a query is carried out on each consumer to acquire the current operating state, or the current power supply of the respective consumer is measured, and the current operating state is determined based on this. Alternatively, the operating state is determined based on a previous control signal of the respective consumer. Thus, the current operating state is the operating state specified by a previous control signal.

In addition, a control record can be created for the consumers, and the consumers are operated according to the control record. In particular, the control record specifies the operating state of the respective consumer. For example, a certain performance target is assigned to the respective consumer, or the control record is used to specify how the respective consumer is to be operated.

For example, the complete control record is transmitted to all consumers, which reduces the susceptibility to errors and increases redundancy. Alternatively, only a control command corresponding to the control record is transmitted to the consumers. Preferably, a corresponding control command is created for each consumer. For example, the control command is only transmitted to the consumer to whom it corresponds, so that the amount of data to be transmitted is reduced. In a preferred variant, the corresponding control command is only transmitted to those consumers for whom a change in the operating state is to take place. Thus, the amount of data to be transmitted is further reduced, which is why hardware requirements are reduced on the one hand. On the other hand, the method can be carried out comparatively robustly in this way. For example, the control record or the respective control command is transmitted to the consumers by means of a cable or, preferably, by radio. This reduces the production costs of the virtual power plant.

The control record can be created such that an auxiliary variable is minimal. The auxiliary variable is created based on the current operating states and on a deviation between a setpoint value for a power requirement and a forecast value. The power requirement here corresponds in particular to a decrease in electrical power. The setpoint value, for example, varies over time and is adapted to current requirements in particular. However, a constant setpoint is particularly preferred, as this reduces the effort and hardware resources required.

The forecast value can correspond to the power requirement of the consumers when operating according to the control record. In other words, the power requirement that the consumers have during operation according to the control record is assumed, and this assumption is used as the forecast value. The power requirement is in particular a theoretical value and is determined, for example, based on a theoretical model or based on a characteristic map. In particular, the forecast value corresponds to the assumed actual value for the power requirement.

In summary, the auxiliary variable can be functionally related to the current operating states of the consumers and the deviation between the setpoint value and the forecast value. Consequently, the control record used to control the consumers meets a certain specification with regard to the current operating states and the deviation. In other words, the control record is created in such a way that a certain condition for the deviation as well as for the current operating states is met, which is specified based on the embodiment of the auxiliary variable. In different words, the operation of the consumers according to the control record takes into account the deviation between the assumed actual value for the power requirement and the setpoint value on the one hand and the current operating states on the other hand, in particular a change in the current operating states.

The method makes it possible to add a heat pump to a potentially existing virtual power plant or to create a virtual power plant using one, or only, heat pumps. This makes it possible to expand existing virtual power plants so that output is increased. It is also possible to create virtual power plants based on consumers that have not yet been used. This broadens the range of applications. Since the setpoint value for the power requirement is usually fulfilled during operation of the virtual power plant, depending on the design of the auxiliary variable, the compatibility of the virtual power plant is increased, especially if the setpoint value is selected for a certain compatibility. In other words, in particular, a retroactive effect of the virtual power plant on the supply network is reduced, and the virtual power plant is used in particular to provide ancillary services, appropriately voltage maintenance and/or grid frequency maintenance. At the very least, the virtual power plant is used to stabilize the electrical voltage supplied by the supply network, and it is useful to use the virtual power plant to consume electrical power in accordance with the setpoint value.

Since the current operating states are taken into account when determining the control record, it is possible to reduce the load on the individual consumers, for example a mechanical and/or electrical load. In particular, the auxiliary variable is adapted in such a way that the load on the heat pump is reduced, preferably on any mechanical components. This reduces the susceptibility to errors of the virtual power plant and increases robustness. This reduces wear and tear on consumers, for example, and they have a comparatively long service life. Due to the reduced load, a user of the heat pump is therefore not prevented from making their heat pump available to the virtual power plant. Thus, acceptance is increased and the possibility of creating a large number of such virtual power plants is given.

Conveniently, the virtual power plant can have a control unit by means of which the method is carried out at least in part. The control unit is connected to the consumers, in particular via signaling technology. For example, the method is only carried out once. However, it is particularly preferable that the method be essentially carried out continuously as long as the setpoint value applies. As a result, the operation of the consumers is thus adjusted so that the condition specified by the auxiliary variable is fulfilled with regard to the current operating states as well as with regard to the deviation.

If the virtual power plant has one or more electricity generators, these are taken into account in particular, and the setpoint corresponds in particular to the power requirement, i.e., the value of the electrical power that is drawn from the potential supply network. For this purpose, the electrical power provided by the power generators is suitably determined, for example measured.

For example, the variance or standard deviation can be used as the deviation. However, the mean absolute error is particularly preferred as the deviation, i.e., in particular the absolute value of the difference between the setpoint value and the forecast value. This facilitates the determination process, and in particular ensures a comprehensible interplay with the consideration of current operating states when determining the auxiliary variable. In particular, the forecast value is an assumption of the power requirement if the consumers are operated according to the control value. The setpoint value, on the other hand, is specified externally.

For example, a minimization algorithm is used to determine the control record. For example, the minimization algorithm is a heuristic or an exact minimization algorithm. When the minimization algorithm is executed, a preliminary control record is first created and preferably the operating states resulting from it are determined. The power requirement resulting from the preliminary control record is determined, and the deviations are calculated from this. The value of the auxiliary variable is determined based on these parameters and the operating parameters. This is done several times, varying the preliminary control record until a minimum is found. The corresponding preliminary control record is used as the new control record. Alternatively, an MPC algorithm is used, i.e., a "model predictive control" algorithm. This makes it possible to determine the control record in a comparatively short period of time.

For example, the auxiliary variable includes a case distinction, wherein the individual cases are specified in particular by examples based on the current operating states and/or the deviation. Particularly preferred, however, the auxiliary variable comprises a weighted sum of the deviation of a variable. Conveniently, the auxiliary variable is formed by means of the weighted sum. In other words, the weighted sum is used as an auxiliary variable. For example, the variable is adapted in such a way that the consumers are operated in the desired operating state. Preferably, the variable indicates a necessary change in the operating state for each consumer. In particular, the variable is increased if a change in the operating state is necessary due to the control record used.

In other words, when determining the auxiliary variable, not only the current operating states are taken into account, but the change required due to the control record used. In particular, the variable is adjusted in such a way that the number of necessary changes in the operating states during the execution of the method, i.e., as long as the setpoint value applies, is optimal, preferably minimal. In particular, for each change, the variable is increased by a value which, for example, is a constant value or adapted to the respective consumer. As a result, the control record used to operate the consumers is the one for which a change and/or number of changes in the operating states is comparatively low. In particular, this results in essentially constant operation of the respective consumers, so that the load on them is reduced. This also makes it clear to users of consumers operation is essentially constant, which increases acceptance. The use of the weighted sum reduces the amount of effort required. In particular, it is also possible to adjust the weights to the needs of the users and/or the consumers used, so that, for example, the deviation or the number of changes in the operating states is reduced to a greater extent.

For example, for the heat pump, a certain electrical power to be consumed is specified by means of the control record. However, it is particularly preferable to store only a binary setting for the heat pump in the control record. Thus, the control record only has a binary setting for the heat pump. In particular, the setting specifies whether the heat pump is operated or not. The heat pump should operate when one of the values is set, and otherwise not. In this way, it is possible to use an existing so-called "Smart Grid Ready" connection or "Smart Grid Ready" interface of the heat pump, which is why there are no additional requirements for the heat pump to be added to the virtual power plant. On the other hand, the operation of a heat pump depends on a comparatively large number of parameters and environmental influences that do not have to be taken into account in this design of the method. It is only necessary to either put the heat pump into operation or to stop/pause operation, i.e., to switch off the heat pumps. This means that users of the heat pump can still adjust the individual settings of the heat pump themselves, such as hysteresis, heating temperature, etc., so that it can be operated in a way that is tailored to the actual installation situation. The adjustment of the heat pump also remains within the sphere of influence of the user/owner of the heat pump. This means that the necessary data exchange between the heat pump and, in particular, a control unit by means of which the method is carried out is reduced. In this way, the individual operating data of the heat pump also remain within the user's sphere of influence, so that data protection is improved and data security is increased. Furthermore, it is not necessary to take into account any safety regulations and/or restrictions when carrying out the method, and the heat pump itself ensures that these are met. Thus, no certification or the like is required for the operation of the virtual power plant.

For example, the forecast value can be created using an artificial intelligence algorithm and/or an extrapolation of a current actual value for the power requirement. For this purpose, the actual value is first determined, for which the actual power requirement required by the consumers is measured. Alternatively, the full (aggregated) power requirement is used. However, it is particularly preferable to create the forecast value based on consumption profiles, with each consumer assigned one of the consumption profiles. By means of the respective consumption profile, a required electrical power is plotted over time, i.e., in particular the temporal course of the electrical power required/used. For example, if the consumer is an electric vehicle, the consumption profile corresponds to a power limit or any value between the power limit and a consumer demand of 0 W. For an electric vehicle, the electrical power used for charging is essentially freely selectable, at least as long as the electric vehicle is not yet fully charged. Preferably, the consumption profile is used to take into account whether the electric vehicle is available for the entire period for which the setpoint value applies and/or it is taken into account as a boundary condition whether a journey is imminent, and thus that the electric vehicle should be charged at a certain time. In particular, the consumption profile corresponds to the current operating state of the consumer, i.e., in particular whether the electric vehicle is being charged. The consumption profile for the heat pump, for example, is theoretically or empirically determined.

Alternatively or in combination with this, machine learning, i.e., in particular an "artificial intelligence" algorithm, can be used to determine the consumption profiles. In particular, the algorithm determines whether the electric vehicle actually exists, or how likely it is that it will be disconnected by a user and thus no longer form part of the virtual power plant, while the setpoint applies.

It is particularly preferable to determine the actual value of the power requirement, record it appropriately, and compare it with the forecast value. Depending on the comparison, the consumption profiles are then adjusted. For example, this is only done for one or more of the consumers, preferably the heat pump. Preferably, this is done for all consumers.

For example, the actual value of the power requirement of the complete virtual power plant is determined. However, it is particularly preferable to determine the actual value for all consumers and compare it with the forecast value, namely preferably a part of it, suitably the respective consumption profile used. For example, the actual value is used as the new consumption profile. Alternatively, the actual value is determined several times, expediently for a certain period of time. For example, the mean value of these actual values is used as a new consumption profile, wherein, for example, a standard deviation/variance is also taken into account. This is expedient, provided that the consumer corresponds to an electric vehicle. Machine learning is particularly preferred for adjusting consumption profiles. For example, an "artificial intelligence" (AI) algorithm is used. For example, a neural network is used for this purpose. However, a Gaussian process regression is particularly preferred for adaptation.

The adjusted consumption profiles are expediently used to recreate the forecast value. This happens, for example, when the method is carried out again, wherein it is first terminated and then restarted, for example. Preferably, however, at least as long as the setpoint value applies, the forecast value is continuously redetermined during the process, so that the control record in particular is also recalculated. Due to the now adjusted consumption profiles, the deviation is therefore reduced in particular. In particular, the adjustment of the consumption profiles is carried out in certain time steps, in particular the length of such a step being between 1 second and 20 minutes, preferably between 30 seconds and 5 minutes. Appropriately, the consumption profiles are recreated every minute and thus also the forecast value. Consequently, a new control record is also created in this case. Thus, there is a comparatively exact correspondence between the actual value and the setpoint value, wherein the effort is comparatively low.

For example, the setpoint for the full time that the virtual power plant is operated is specified. However, it is particularly preferable for the setpoint value to only be used for a predefined time window. In other words, the setpoint only applies to the time window. In particular, predefined time periods are available, wherein there is only one such time window per time period, during which operation takes place in accordance with the setpoint value. Outside the time window, it is also advisable to operate the virtual power plant, but no setpoint value is specified. In particular, the method is terminated at the end of the time period and preferably restarted for the next time period.

In particular, the time window is not more than half of the length of the time period. Preferably, 24 hours, i.e., one day, is used as a predefined time period. Thus, a setpoint value is specified once for each day. In particular, the time window is between 15 minutes and 5 hours, between 30 minutes and 2 hours and, for example, essentially equal to 1 hour, wherein there is a deviation of 25%, 10%, 5% or 0%, for example. During the time window, the virtual power plant serves in particular to stabilize the supply network, whereas otherwise the operation of the consumers is not limited by the setpoint value. For example, the time window is divided into several time intervals that are spaced apart. Preferably, however, the time window is contiguous, which makes it easier to determine the control record.

This makes it possible to operate the consumers outside the time window according to the wishes of the respective user, so that comfort is increased for the user. Due to the operation by means of the setpoint, the comfort during the time window is only slightly reduced. Since the time window is comparatively short, there is at most a slight reduction in comfort, especially with the heat pump, because during the time window the thermal buffer storage tank, for example, is heated slightly more or slightly less than desired. Subsequently, however, operation resumes, for example according to a heating curve. However, using the setpoint during the time window improves the stability of the supply network.

For example, the setpoint is essentially chosen arbitrarily or according to certain specifications. However, a maximum value and a minimum value for the power requirement during the predefined time window are particularly preferred. The minimum value and/or the maximum value are conveniently variable or, for example, constant. The setpoint is then chosen between these two. This ensures that the setpoint value can actually be achieved. The maximum value and the minimum value apply in particular to the complete virtual power plant. In particular, the maximum value and the minimum value are determined in advance, in particular with a time gap relative to the predetermined time window. It is particularly preferable to communicate this after these have been determined, for example to an operator of the supply network, in particular in the form of an offer. The operator or another person then specifies the setpoint value and thus selects it. Appropriately, the method is part of a business model, wherein the minimum value and the maximum value are specified by the operator/owner of the virtual power plant, in particular to the operator of the supply network. From this, the setpoint value is selected between the minimum value and the maximum value. Subsequently, the virtual power plant is operated for the specified time window, using the setpoint. In return for the operator of the virtual power plant consuming the electrical output corresponding to the setpoint value during the time window, the operator receives a compensation payment from the operator of the supply network.

For example, any value is used as the minimum value. Preferably, the minimum value is 0 W, or each consumer has a minimum requirement assigned to it, and the minimum value is the sum of all the minimum requirements. For example, the maximum value is theoretically determined or always corresponds to the same value. This value is preferably less than the sum of all the power requirements of the consumers at maximum output. This ensures that the maximum value can be achieved using the virtual power plant.

Particularly preferably, however, the maximum value corresponds to the operation of the consumers according to a second control record. In other words, it is predicted/assumed how great the power requirement of consumers would be if they were operated with the second control record. In other words, the maximum value is an assumed value. In particular, any consumption profiles are used to determine the maximum value. The second control record is created in such a way that a second auxiliary variable is minimal. For example, the second auxiliary variable is created in the same way as the auxiliary variable. It is particularly preferred for the second auxiliary variable to be created based on predicted operating states, i.e., assumed operating states, and based on a deviation between the maximum value and the forecast value. Furthermore, the second auxiliary variable is also created based on the maximum value itself. Preferably, the second auxiliary variable is created in the same way as the auxiliary variable, but the maximum value is also taken into account. For example, the same predicted operating states are always used to determine the maximum value, or these can also change for the predefined time period. Preferably, the second auxiliary variable comprises a weighted sum of the deviation between the maximum value and a second variable that indicates a required change in the predicted operating state for each consumer, and the reciprocal of the maximum value or the negated maximum value. Conveniently, the second auxiliary variable is formed by means of this sum. In summary, the second control record is created in such a way that the maximum value is as large as possible, wherein the deviation between the maximum value and the forecast value is as small as possible, and wherein the number of changes to the operating states required for this purpose is as small as possible for the time window.

If the virtual power plant has one or more power generators, it is preferred that a forecast for the electrical power be provided by the power generators for the time window. The forecast is taken into account in particular when determining the maximum value, and this is reduced by this value in particular as compared to the use of only the (assumed) power requirement of the consumers.

For example, the predefined time window is always the same or different per time period. Particularly preferably, the maximum value and the minimum value are determined for each time period for several such time windows. These can differ, especially depending on the operating states predicted at that time. Alternatively or in combination, these differ because there is a different number of consumers, especially if at least a portion of them are electric vehicles. For example, the time period also has times that are not assigned to any of the time windows. However, it is particularly preferable to divide the time period between the time windows, which preferably have the same length.

A time window is selected from the time windows. The setpoint then applies to this. For example, depending on the selected setpoint, the time window is selected, or the setpoint value is selected for the selected time window. Once the time window has begun, the control record is created using the auxiliary variable and the consumers are operated accordingly. In particular, the potential business model is adapted in such a way that the operator of the virtual power plant offers the minimum value and the maximum value for each of the time windows, wherein one of the time windows is selected by the operator of the supply network and the setpoint value valid for it is specified, which lies between the minimum value applicable to the time window and the maximum value. In particular, the operator of the virtual power plant receives compensation for the corresponding operation or the price for the electrical power consumed during the time window is reduced.

The virtual power plant has a number of electrical consumers. These are, for example, locally arranged or distributed. In the assembly state, the consumers are electrically connected to a supply network, for example, via a common supply connection or each consumer individually. One of the consumers is formed by means of a heat pump. For example, all consumers are heat pumps, or at least several of the consumers are heat pumps. For example, one of the consumers is an electric vehicle, an air conditioner, a refrigerator, or a server system. For example, the virtual power plant has one or more power generators, at least some of which are powered by renewable energies. Alternatively, the virtual power plant is, for example, without a power generator and thus formed only by means of the consumers. At the very least, the virtual power plant has a power requirement when it is in operation. The virtual power plant is operated according to a method in which a current operating state of each consumer is acquired. A control record for consumers is drawn up, and consumers are operating according to the control record. The control record is created in such a way that an auxiliary variable is minimal, which is created based on the current operating states and on a deviation between a setpoint value for a power requirement and a forecast value that corresponds to a power requirement of the consumers when operating according to the control record.

In particular, the virtual power plant has a control unit that is provided and configured to carry out the method. The control unit includes, for example, an application-specific circuit (ASIC) or, most preferably, a computer that is suitably programmable. In particular, the control unit comprises a storage medium, i.e. a non-transitory computer readable medium, on which a computer program product, also known as a computer program, is stored, wherein when that computer program product, which is to say, the program, is executed, the computer is induced to carry out the method. Conveniently, the control unit is connected to all consumers and/or the supply connection by signal, preferably by means of a corresponding connection of the control unit. For example, the control unit is directly connected to each individual consumer separately. Alternatively, a bus system is formed. For example, the signaling connection is made by means of a line or, suitably, at least partly by means of a radio connection, which in particular meets a Bluetooth, cell phone or WLAN standard. In particular, the control record or at least part of it is transmitted to the respective consumers by means of the signaling connection.

The invention also relates to such a control unit. The control unit is provided and configured to carry out a method for the operation of a virtual power plant which has several electrical consumers, at least one of which is formed by means of a heat pump. In the method, a current operating state of each consumer is acquired and a control record for the consumers is created. The consumers are then operated according to the control record. The control record is created in such a way that an auxiliary variable is minimal, which is created based on the current operating states and on a deviation between a setpoint value for a power requirement and a forecast value. The forecast value corresponds to the power requirement of the consumers when operating according to the control record.

For example, the control unit has an application-specific circuit (ASIC) and/or a microprocessor by means of which the method is at least partially carried out. In particular, the control unit comprises a computer program product stored on a memory which, when the program is executed by a computer, such as the microprocessor, causes the computer to carry out the method. Preferably, the control unit in the assembly state is a component of one of the consumers, preferably the heat pump, or a higher-level control system of the virtual power plant. For example, the control unit is used to form the higher-level control unit. Thus, other functions are also taken over by means of the control unit.

The computer program product comprises a number of commands which, when the program (computer program product) is executed by a computer, cause it to carry out a method for the operation of a virtual power plant that has several electrical consumers, at least one of which is formed by means of a heat pump. In the method, a current operating state of each consumer is acquired and a control record for the consumers is created. The consumers are then operated according to the control record. The control record is created in such a way that an auxiliary variable is minimal, which is created based on the current operating states and on a deviation between a setpoint value for a power requirement and a forecast value. The forecast value corresponds to the power requirement of the consumers when operating according to the control record. The computer is conveniently a component of a control unit and is formed, for example, by means of it. The computer preferably comprises a microprocessor or is formed by means of it. For example, a computer program product is a file or data medium that contains an executable program that automatically performs the method when installed on a computer.

The invention also relates to a storage medium on which the computer program product is stored. Such a storage medium is, for example, a CD-ROM, a DVD or a Blu-Ray Disc. Alternatively, the storage medium is a USB stick or other storage device that can be rewritten, for example, or can only be written once. Such a storage medium is, for example, a flash memory, a RAM or a ROM.

The further developments and advantages explained in connection with the method are also to be transferred mutatis mutandis to the virtual power plant / the control unit / the computer program product / the storage medium as well as to each other, and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is schematically, a virtual power plant,

FIG. 2 is a method for operating the virtual power plant,

FIG. 3 is a time period that has several time windows,

FIG. 4 is several consumption profiles and the resulting temporal progression of a maximum value for one of the time windows, and

FIG. 5 is several consumption profiles and the resulting temporal course of a forecast value, as well as a setpoint and an actual value for the time window.

### DETAILED DESCRIPTION

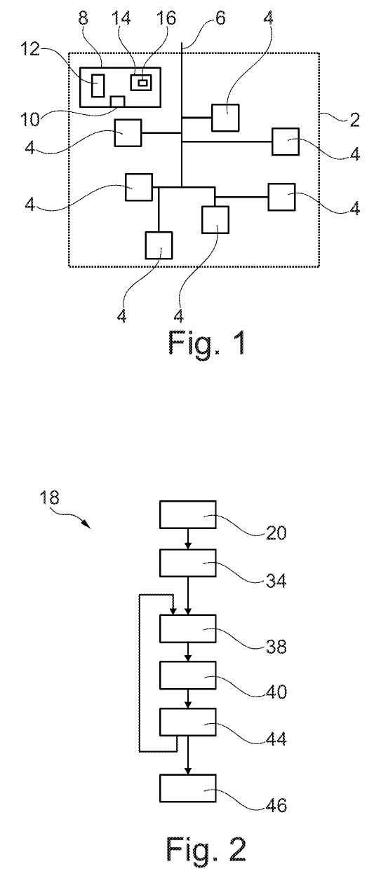

FIG. 1 schematically shows a virtual power plant 2 that has several electrical consumers 4, which are also referred to simply as consumers 4. The virtual power plant 2 is electrically connected to a supply network via a supply connection 6. A three-phase electrical alternating voltage is carried by means of the supply network. In the example shown, the virtual power station 2 does not include a power generator and is therefore without a power generator. Each of the consumers 4, if it is operated, has a power requirement. This is covered by a supply network. For this purpose, the consumers 4 are electrically contacted with each other as well as with the supply connection 6. Thus, by means of the virtual power plant 2, electrical power is only drawn from the supply network during operation, namely if the consumers 4 are operated accordingly.

Some of the consumers 4 are each formed by means of an electric vehicle, which is charged as part of the operation of the virtual power plant 2. If the respective electric vehicle is used, i.e., driven, by a user, it is detached from the network of the virtual power plant 2 and thus no longer forms part of the virtual power plant 2. Thus, some of the consumers 4 are only temporarily assigned to the virtual power plant 2.

Several of the consumers 4 are each formed by means of a heat pump. Every heat pump is part of a heating system that also has a thermal buffer storage tank. The heat pumps are assigned to different structural units and are operated in different ways, depending on the settings of the respective user. For example, it is possible that so-called heating curves and/or domestic hot water temperatures differ between the individual heat pumps/heaters, so that the consumers 4 are operated differently. It is also possible that the individual heat pumps have different hardware.

However, the heat pumps each have an "SG Ready" interface ("Smart Grid Ready" interface) and, like the other consumers 4, are connected to a control unit 8 for signaling purposes. For this purpose, the control unit 8 has a communication device 10, which is equipped for radio communication. The communication device 10 complies with a Wi-Fi, cell phone and/or Bluetooth standard. The virtual power plant 2 is operated by means of the control unit 8, and the control unit 8 is suitable for this purpose, as well as provided and configured.

The control unit 8 comprises a computer 12 in the form of a programmable microprocessor and a storage medium in the form of a memory 14. A computer program product 16 is stored in the memory 14, which comprises several commands which, when the program is executed by the computer 12, cause it to execute a method 18 for the operation of the virtual power plant 2 shown in FIG. 2. In other words, the virtual power plant 2 is operated in accordance with the method 18 and the control unit 8 is provided and configured to carry out the method 18.

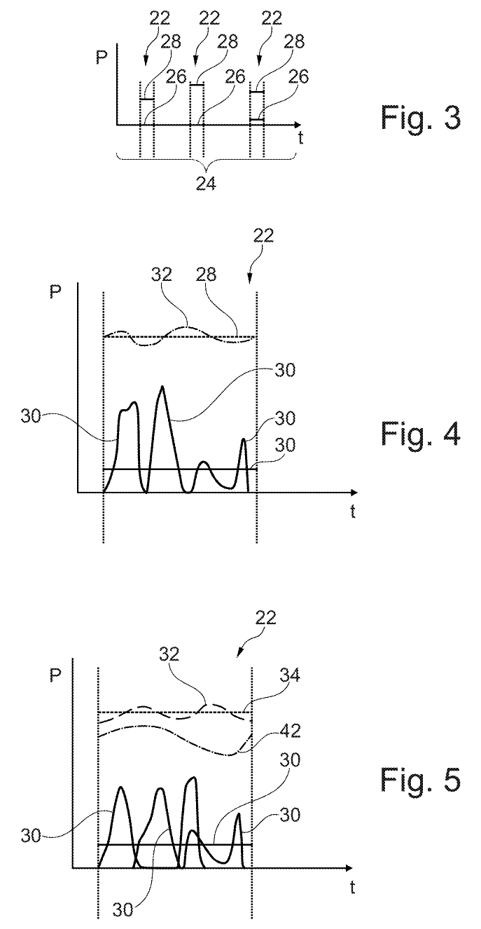

In a first step 20, a minimum value 26 and a maximum value 28 each are determined for three predefined time windows 22 of a predefined time period 24 shown in FIG. 3. The length of the predefined period 24, also referred to simply as the time period, is 24 hours, and the method 18 is carried out at the beginning of the time period 24, but before any of the time windows 20 have begun. The length of each predefined time window 22, also known simply as a time window 22, is 1 hour. In the example shown, the position of the time windows 22 in the time period 24 is always the same, even when the method 18 is carried out subsequently. The minimum values 26 and maximum values 28 are constant during the respective time window 22 but may differ between the individual time windows 22. In the example shown, the minimum value 26 is equal to 0 W for the first two time windows 22. In the subsequent, i.e., last, time window 22 of the time period 24, the minimum value 26 is increased and corresponds to the sum of the power requirement if all consumers 4 are operated with minimum power.

The maximum value 28 corresponds to the operation of the consumers 4 during the respective time window 22 corresponding to a second control record, wherein the maximum value 28 is constant and corresponds in particular to a second setpoint value. In order to determine the maximum value 28, it is first determined which power requirement the individual consumers 4 have when they are operated according to the second control record. For this purpose, a consumption profile 30 assigned to the respective consumer 4 is used, three of which are shown as examples in FIG. 4. The consumption profiles 30 are stored in the memory 14 and correspond to an assumed power requirement of the respective consumers 4. In this case, a certain operating state is assumed for each consumer 4, which results from the second control record used. Based on the operating states predicted in this way, the respective consumption profile 30 is calculated.

The consumption profile 30 for each electric vehicle is constant and corresponds to the maximum power consumption when the respective electric vehicle is charged. In other words, the consumption profile 30 of the electric vehicle thus speaks of operation with full charging power.

The consumption profiles 30 of the heat pumps, on the other hand, are modified and have different shapes, which depend on the respective setting, such as a desired domestic hot water temperature. This is not specified by the second control record; rather, it merely specifies in binary terms whether the respective heat pump is operated or not. In other words, only one binary setting is stored for the heat pumps in the second control record. However, it is possible to flexibly choose the times at which the respective operating state is changed, i.e., whether the heat pump is operated or not, within the time window 22. The consumption profiles 30 do not always differ from 0 W during the complete time window 22 in order to avoid overheating of the assigned thermal buffer storage tank.

The sum of the consumption profiles 30 corresponds to a forecast value 32. Since the consumption profiles 30 are variable in time, the forecast value 32 also changes during the time window 22. The deviation, i.e., the mean absolute error, between the forecast value 32 and the (assumed) maximum value 28 for the time window 22 is created. A variable is also determined that corresponds to the number of changes in the operating states of the consumers 4 during the time window 22. The deviation, the variable and the negation of the maximum value 28, i.e., the maximum value 28 multiplied by "-1" ("minus one"), are weighted differently and summed up to form a second auxiliary value. The second control record is changed until the second auxiliary variable is minimal. For example, a minimization algorithm is used for this purpose, in particular a "Model predictive control" algorithm (MPC), wherein a "mixed-integer linear problem solver" is appropriately used.

Since the predicted operating states of the consumers 4 may differ for the different time windows 22, the maximum values 28 of the time windows 22 are also different: For example, it is possible that the number of existing electric vehicles 4 has changed in one of the time windows 22, or that, for example, that one of the heating systems to which one of the heat pumps is assigned had a comparatively high demand for heating power, so that now only comparatively low power consumption is possible without overheating.

In summary, the maximum value 28 thus corresponds to an operation of the consumers 4 according to the second control record, wherein the second control record is created such that the second auxiliary variable is minimal. The second auxiliary variable in turn is created based on the predicted operating states, based on the deviation between the maximum value of 28 and the forecast value of 32 and based on the maximum value 28 itself. The forecast value 32 corresponds to the sum of the power requirements of the consumers 4 in an operation corresponding to the second control record, and the maximum value 28 is constant for the time window 22. For the predefined period 24, the maximum value of 28 and the minimum value of 26 are each determined for the three time windows 22. In an unspecified variant, the full time period 24 is divided into time windows 22. Thus, there are a total of 24 such time windows 22, and for each the minimum value 26 and the maximum value 28 are determined.

In a second step 34, the timing of each time window 22 as well as the minimum values 26 and maximum values 28 applicable to them are transmitted from the operator of the virtual power plant 2 to the operator of the supply network. From this, one of the predefined time windows 22 is selected. Furthermore, a setpoint value 36 is chosen for the time window 22, which is shown in FIG. 5. The setpoint value 36 is in the minimum value 26 and the maximum value 28 of the selected time window 22. In this case, the setpoint value 36 is only selected for one of the time windows 22 of the time period 24.

As long as the selected time window 22 has not yet begun, the consumers 44 are only operated in accordance with the specified settings/specifications of the respective user. Thus, the power requirement of the virtual power plant 2 is essentially predetermined by the needs of the users and can show comparatively high fluctuations. Once the selected time window 22 has begun, a third step 38 is performed. In it, a current operating state of each consumer 4 is first acquired. The consumers 4 designed as heat pumps are checked as to whether they are currently in operation or not. In the consumers 4 designed as electric vehicles, the current power consumption is recorded.

In the third step 38, a control record for the consumers 4 is also created. For this purpose, the forecast value 32 is first determined, which corresponds to the power requirements of the consumers for an operation according to the control record. But here, only a binary setting is stored for the heat pumps in the control record. The forecast value 32 is determined for the complete time window 22, wherein the operating state of each consumer 4 is changed during the time window 22 as a function of the control record. The deviation between the forecast value 32 and the setpoint value 34, which is constant for the time window 22, is determined, wherein the mean absolute error is also used as the deviation. The forecast value 32, just like in the first step 22, is created using the consumption profiles 30, with one assigned to each consumer 4. For each of the consumption profiles 30, the current operating state of the respective consumer 4 is taken into account.

In addition, the number of changes in the operating state required to realize this forecast value 32 is determined, and the sum of these is used as a variable. This variable and the deviation are weighted and summed up to form an auxiliary variable. In other words, the auxiliary variable is formed by the weighted sum of the deviation between the setpoint value 34 and the forecast value 32 and the variable indicating the required change in the operating states for each consumer 4.

The control record is varied until the auxiliary variable is minimal. Here, too, a "Model predictive control" (MPC) algorithm is used, wherein a "mixed-integer linear problem solver" is appropriately used. In summary, the control record is determined in the same manner as the second control record, wherein the negated value of the maximum value 28 is not used, and setpoint value 34 is used instead of the maximum value 28. Also, instead of the predicted operating states, the current operating states of the consumers 4 are used. In the example shown in FIG. 5, one of the consumption profiles 30 is divided into two time periods that are disjoint from each other, since the setpoint value 34 is lower than the maximum value 28. The operating states are also changed, for example, as compared to the predicted operating states.

The control record created in this way is used for the operation of the consumers 4. For this purpose, the control record is transmitted to them so that the consumers 4 are operated according to the control record. In this case, only the portion of the control record applicable to each consumer 4 is transmitted, thus reducing the amount of data transferred.

In a subsequent fourth step 40, an actual value 42 of the power requirement is measured and compared with the forecast value 32. For each of the consumers 4, the actual power requirement, i.e., the respective actual value, is measured and compared with the respective consumption profile 30 based on which the sum of the forecast value 32 is determined. In the example shown, there is a comparatively large discrepancy.

In a subsequent fifth step 44, the consumption profiles 30 are adjusted as a function of the comparison. For consumers designed as electric vehicles, the actual power consumption is compared with the predicted power consumption, i.e., the consumption profile used 30. If these differ by more than a tolerance value, the mean value of the (actual/realized) power consumption is used as the new consumption profile 30 for the electric vehicle, wherein a standard deviation is also taken into account. In a further development, machine learning is used for adjustment. In the consumers 4 designed as heat pumps, machine learning is also used to adjust the respective consumption profile 30, namely a Gaussian process regression.

Once the consumption profiles 30 have been adjusted, which is conveniently done every minute, the third step 38 is carried out again, this time using the adjusted consumption profiles 30. In other words, the control record is now created based on the adjusted consumption profiles 30. As a result, the deviation between the forecast value 32 and the actual value 42 is reduced, and this is essentially the same as the setpoint value 34. Subsequently, the fourth step 40 and the fifth step 44 are carried out again, and the consumption profiles 30 are adjusted again if necessary. The third, fourth and fifth steps 38, 40, 44 are thus repeated several times during the time window 22.

Due to the use of the control record, the behavior of the consumers 4 during the time window 22 does not fully correspond to the wishes of the respective users. However, one of the power requirements of the virtual power plant 2 during the time window 22, namely the actual value 42, is comparatively constant, which is why the load on the supply network is reduced, or why the virtual power plant 2 contributes to the stabilization of the supply network 2. When the time window 22 ends, a sixth step 46 is carried out, and the consumers 4 are operated again according to the user specifications. After the end of the time period 24, the method 18 is terminated and immediately started again for the following period 24.

The invention is not limited to the embodiment described above. Rather, other variants of the invention can also be derived from this by the skilled person without departing from the subject-matter of the invention. In particular, all the individual features described in connection with the embodiment can also be combined with each other in other ways without departing from the subject-matter of the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating a virtual power plant which comprises a plurality of electrical consumers, at least one of which is formed by a heat pump, the method comprising:
acquiring a current operating state of each consumer;
creating a control record for the consumers; and
operating the consumers in accordance with the control record,
wherein the control record is created such that an auxiliary variable, which is created based on the current operating states and on a deviation between a setpoint value for a power requirement and a forecast value that corresponds to a power requirement of the consumers during operation in accordance with the control record, is minimal.

2. The method according to claim 1, wherein the auxiliary variable has a weighted sum of the deviation and a variable which indicates a necessary change in the operating state for each consumer.

3. The method according to claim 1, wherein only a binary setting is stored for the heat pump in the control record.

4. The method according to claim 1, wherein the forecast value is created based on consumption profiles, wherein each consumer is assigned one of the consumption profiles.

5. The method according to claim 4, wherein the forecast value is compared with an actual value of the power requirement, wherein the consumption profiles are adjusted depending on the comparison.

6. The method according to claim 1, wherein the setpoint is only used for one predefined time window per predefined time period.

7. The method according to claim 6, wherein a maximum value and a minimum value for the power requirement are determined during the predefined time window, abd wherein the setpoint value is chosen between these two.

8. The method according to claim 7, wherein the maximum value corresponds to an operation of the consumers in accordance with a second control record, and wherein the second control record is created such that a second auxiliary variable, which is created based on predicted operating states and based on a deviation between the maximum value and the forecast value and based on the maximum value itself, is minimal.

9. The method according to claim 7, wherein, for the predefined time period, the maximum value and the minimum value are determined for several such time windows, and that one of the time windows is selected.

10. A Virtual power plant comprising a plurality of electrical consumers, at least one of which is formed by a heat pump, and which is operated in accordance with the method according to claim 1.

11. A non-transitory computer readable medium comprising a computer program product that comprises commands which, when executed by a computer, cause it to execute the method according to claim 1.
